(19) United States
(12) Patent Application Publication
(10) Pub. No.: US 2021/0288814 A1
(43) Pub. Date: Sep. 16, 2021

(54) A BLOCK CHAIN-BASED SYSTEM FOR MULTI-PARTY, MULTISTAGE PROCESS VERIFICATION

(71) Applicants: NEWSOUTH INNOVATIONS PTY LIMITED, Sydney (AU); THE COMMONWEALTH OF AUSTRALIA REPRESENTED BY THE DEPARTMENT OF DEFENCE, Canberra BC (AU)

(72) Inventors: Stuart GREEN, Canberra Airport (AU); Amit GHILDYAL, Canberra Airport (AU); Elizabeth CHANG, Canberra Airport (AU)

(21) Appl. No.: 17/300,141

(22) PCT Filed: Sep. 18, 2019
(86) PCT No.: PCT/AU2019/050997

§ 371 Date: Mar. 18, 2021

(30) Foreign Application Priority Data
Sep. 18, 2018 (AU) 2018903509

(51) Int. Cl. H04L 9/32; G06N 20/00; H04L 9/08

(52) U.S. Cl. CPC H04L 9/3236; H04L 9/088; G06N 20/00

(57) ABSTRACT

A block chain-based system for multi-party, multistage process verification has a server in operable communication with a plurality of electronic client terminals. The server has a database which may have user data and implement a process verification controller. The system further has a block chain ledger. Fora multistage process involving multiple users, for each stage, the system is configured for receiving a function ID selected from a set of available functions via user interfaces of respective client terminals, generating a function hash comprising the function ID and associated function data and creating a function block chain transaction comprising the function hash which is added to the block chain ledger.

### FIELD OF THE INVENTION

This invention relates generally to a system for multi-party, multistage process compliance assurance risk management using block chain-based transactions.

### SUMMARY OF THE DISCLOSURE

There is provided herein a block chain-based system for multi-party, multistage process verification. The system comprises a server in operable communication with a plurality of electronic client terminals. The server comprises a database which may comprise user data and implement a process verification controller. The client terminals may comprise a digital display device displaying a user interface thereon.

The system further comprises a block chain ledger.

For a multistage process involving multiple users, for each stage, the system is configured for receiving a function ID selected from a set of available functions via user interfaces of respective client terminals, generating a function hash comprising the function ID and associated function data and creating a function block chain transaction comprising the function hash which is added to the block chain ledger.

As such, the process verification controller is able to subsequently verify the process by retrieving the function block chain transactions from the block chain ledger. In embodiments, each function hash further comprises an asset ID in relation to a selected function and the available functions presented by the user interfaces may depend on the type of asset.

According to one aspect, there is provided a system comprising: a server comprising a database, the database comprising user data, the server further comprising a process verification controller; a block chain ledger; a plurality of client terminals in operable communication with the server across a wide area network, each client terminal comprising a memory device; a digital display device comprising a user interface wherein, in use, the system is configured for: for each stage of a multistage process involving a plurality of users: receiving a function ID selected from a set of available functions via user interfaces of respective client terminals, generating a function hash comprising the function ID and associated function data; creating a function block chain transaction comprising the function hash; and adding the function block chain transaction to the block chain ledger; and using the process verification controller to inspect the function block chain transactions to verify the multistage process.

The function hash may be a one-way function hash.

The database may comprise asset data and the system may be further configured for receiving an asset ID in relation to the function ID and hashing the asset ID with the function ID and the function data to generate the function hash.

The available functions may be filtered according to asset ID.

The process may have a process ID and wherein function block chain transactions comprise a data field comprising the process ID and the process verification controller may be configured for identifying function block chain transactions relating to the process by identifying the process ID of data fields thereof.

The server may be configured for building a process ID index which may be searched by the process verification controller.

The system may comprise a function verification controller configured to inspect the function block chain transactions and to add verification block chain transactions to the block chain ledger and the process verification controller may be configured for verifying the process further with reference to the verification block chain transactions.

Each verification block chain transaction may comprise a verification result and the process verification controller may be configured for verifying the process according to verification results of the verification block chain transactions.

For a verification block chain transaction comprising a verification result indicative of unsuccessful completion of a function, the process verification controller may be configured for inspecting the block chain ledger for a repeat function block chain transaction associated with a function block chain transaction associated with the verification block chain transaction.

Each verification block chain transaction may comprise a transaction ID of a function block chain transaction.

Each repeat function block chain transaction may comprise a transaction ID of a verification block chain transaction.

The system may comprise a function verification controller configured to verify function block chain transactions added to the block chain ledger.

The database may comprise at least one transaction contract and the function verification controller may be configured for verifying function block chain transactions using the at least one transaction contract.

The function block chain transaction may comprise a data field comprising a transaction ID and the function verification controller may be configured for selecting a transaction contract from the at least one transaction contract according to the transaction ID.

The function contract may specify at least one rule and an output.

The function verification controller may be configured for creating a verification block chain transaction in accordance with the output and adding the verification block chain transaction to the block chain.

The verification block chain transaction may comprise a data field comprising the output.

The system may comprise a supervised machine learning module and the function verification controller may be configured for verifying a function block chain transaction in accordance with an output of the supervised machine learning module.

The system may be configured for storing the function data within a function data database separate from the block chain ledger and the function verification controller may be configured for identifying the function data within the function data database using a function block chain transaction and hashing the function data to form a check hash and comparing the against the function hash of the function block chain transaction verify the function block chain transaction.

The server may comprise an automation processor configured to monitor the block chain ledger and automate a process when a function block chain transaction may be added to the block chain.

The function block chain transaction may comprise a data field comprising a function ID and the automation processor may be configured to automate the process when the function ID matches an automation process ID.

The process may be the sending of an alert to a client terminal.

The function hash may be cryptographically signed with a private key associated with a respective user and the function verification controller may be configured for verifying the function hash using a corresponding public key of a cryptographic key pair.

The database may comprise user hierarchy data and the function hash may be cryptographically signed with private keys of at least two users related by the hierarchy data.

Other aspects of the invention are also disclosed.

### BRIEF DESCRIPTION OF THE DRAWINGS

Notwithstanding any other forms which may fall within the scope of the present invention, preferred embodiments of the disclosure will now be described, by way of example only, with reference to the accompanying drawings in which:

FIG. 1 shows a block chain-based system for multi-party, multistage process verification;

FIG. 2 illustrates exemplary stage processing by the system of FIG. 1;

FIG. 3 illustrates an exemplary block of a block chain ledger in accordance with an embodiment;

FIG. 4 shows an exemplary process verification map representation;

FIG. 5 illustrates an exemplary supervised machine learning module in accordance with an embodiment;

FIG. 6 illustrates exemplary block chain transactions in accordance with an embodiment.

### DESCRIPTION OF EMBODIMENTS

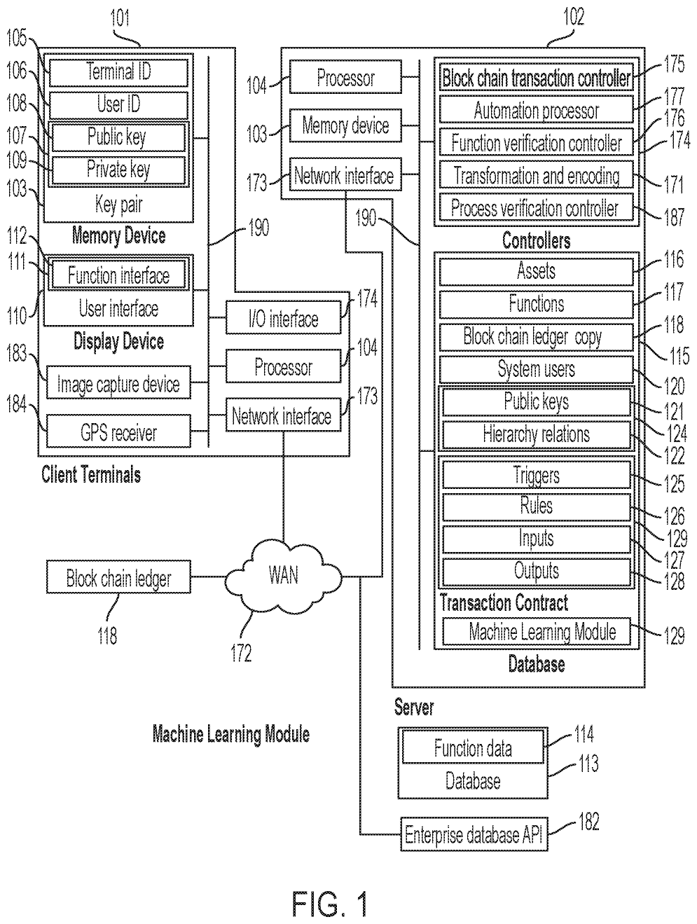

FIG. 1 shows a system 100 comprising a server 102 in operable communication with a plurality of client terminals 101 across a wide area network 172.

The server 102 comprises a processor 104 for processing digital data. The processor 104 is in operable communication with a memory device 103 across a system bus 190.

The memory device 103 is configured for storing digital data including computer program code instructions. The computer program code instructions may be logically divided into various computer program code controllers such as dynamic link libraries (DLLs). In use, the processor 104 fetches these computer program code instructions and associated data from the memory device 103 for interpretation and execution of the computational functionality provided herein.

The server 102 may further comprise a database 115. The database may comprise asset data 116 representative of real-world assets. The asset data 116 may comprise asset IDs and associated meta data.

The database 115 may comprise a plurality of functions 117 which may be represented by function ID. The functions 117 are generally, but not always, functions in relations to the aforedescribed assets. Exemplary functions 117 may, for example, include transport, verify location, verify quantity, purchase, depreciate, assigned serial number, perform service, perform maintenance and the like.

The system 100 comprises a block chain ledger 118. The block chain ledger 118 may be a public block chain ledger such as, for example, the Bitcoin™ block chain ledger 118. In alternative embodiments, the block chain ledger 118 may be a private block chain ledger.

In embodiments, the database 115 comprises a copy of the block chain ledger 118.

The controllers 174 may comprise a block chain transaction controller 175 including for handling aspects of adding transactions to the block chain ledger 118. For example, the block chain transaction controller 175 may listen for block chain transactions, collect a set of block chain transactions and iteratively perform hashing thereon to obtain a hash of the requisite degree of specificity to be able to at the set of block chain transactions to the block chain ledger 118.

The database 115 may comprise a plurality of system users 120. For a system user 120, the database 115 may store public keys 121 which may be used for verification of public/private key pair cryptographically signed transactions. The database 115 may further store hierarchical relations 122 between users.

The database 115 may further store a plurality of transaction contracts 124.

Each contract 124 may comprise triggers 125, rules 126, inputs 127 and outputs 128.

The controllers 174 may comprise a function verification controller 176 which implements the transaction contracts 124 to verify function block chain transactions. The term “function block chain transaction” as used herein, should be construed as being a block chain transaction which is used by the system 100 to represent a function 117.

The function verification controller 176 may listen for blocks added to the block chain ledger 118 and then inspect function block chain transactions therein (including, more specifically, data fields of functions transactions therein) to obtain inputs 127 which are applied against the rules 126 to output outputs 128. Outputs may include verification block chain transactions to the block chain ledger 118. Similarly, “verification block chain transaction” should be construed herein as chain transactions which are used by the system 100 for verifying function block chain transactions.

In embodiments, the controllers 174 may comprise an automation processor 177 which may be configured for automating aspects of the operation of the system 100, such as the sending of alerts.

In embodiments, the database 115 may comprise a supervised machine learning module 129 for the artificially intelligent interpretation and verification of functions 117.

The controllers 174 may further comprise a transform and encoding controller 171 for transforming and encoding data. For example, the confirmation and encoding controller 171 may obtain image data obtained from an image capture device of a client terminal 101 to perform optical character recognition (OCR) thereon to obtain raw text data.

The server 102 may further comprise a network interface 173 for sending and receiving data across the wide area network 172.

The system 100 may further comprise a database 113 for storing function data 114. In embodiments, the database 115 of the server 102 may store all or at least a subset of the function data 114. Function data 114 may, for example, include documentation, images, function meta data such as GPS location coordinates and or the like of assets 116.

The system 100 may further comprise an enterprise database API 182 for communicating with various enterprise databases.

The client terminals 101 may further comprise a processor 104 in operable communication with a memory device 103 across a system bus 190, the memory device 103 storing digital data including computer program code instructions which are fetched, interpreted and executed by the processor 104 for implementing the computational functionality described herein.

Each client terminal 101 is typically a small form factor mobile communication device which may comprise a network interface 173 for sending and receiving data across the wide area network 172. Preferably, the network interface 173 is a wireless interface, such as a Wi-Fi or GSM interface allowing for client terminal 101 portability.

The client terminal 101 may comprise an I/O interface 174 which may interface a digital display device 110 for the display of digital information thereon. A haptic interface may overlay the digital display device 110 for the receipt of user input.

The digital display device 110 may display a user interface 110 comprising a function interface 112. The function interface 112 is configured for performing various functions 117 in relation to various assets 116.

The I/O interface 174 may further deface an image capture device 183 and/or a GPS receiver 184 in embodiments.

In embodiments, the memory device 103 of the client terminal 101 may store a terminal ID 105 uniquely representing the client terminal 101. Furthermore, the memory device 103 may record a user ID 106, uniquely identifying a user of the client terminal 101. Furthermore, the memory device 103 may store a public/private key pair 107 comprising a public key 108 and associated private key 109 which may be used for cryptographic signing, including signing of function hashes or function data prior adding to the block chain ledger 118.

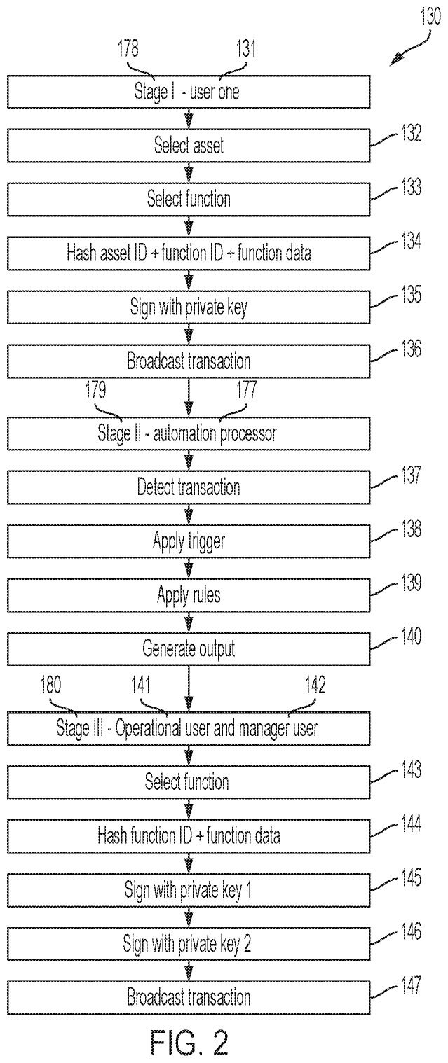

FIG. 2 illustrates exemplary process stage processing 130 performed by the system 100 for a multistage process. For exemplary purposes, the processing 130 is shown being used by three users in a three-stage process. However, it should be appreciated that the processing 130 is applicable for any number of stages and users.

Further for exemplary purposes, the processing 130 will be described with reference to an exemplary asset audit of defence hardware such as defence vehicles such as tanks. Whereas the exemplary asset audit would typically comprise a greater number of stages, for succinctness, stage I 178 is an example stage where a count officer (user one 131) counts the number of vehicles.

As such, using the function interface 121 of the user interface 111 of the client terminal 101, the user 131 selects an asset 116 at step 132. The user interface 111 may, for example, allow the user one 131 to search for a particular vehicle by type, registration, license plate number or the like which is retrieved from the database 115.

At step 133, the user 131 select an available function 117 in relation to the selected asset 116. In embodiments, the interface 111 is configured for only displaying the available functions 117 pertinent to the particular asset 116. As such, for a vehicular asset 116, the available functions 117 may, for example, include transport, assigned serial number, depreciate, write off, verify location and perform maintenance.

In this particular example, for the asset audit, the user 131 selects the location verification function 117.

Using the image capture device 183 of the client terminal 101, the user 131 may capture an image of the vehicular asset 116 as evidence that the vehicle asset 116 is at the particular location. Furthermore, the client terminal 101 may utilise the GPS receiver 184 to capture the location of the client terminal 101.

At step 134, the client terminal 101 creates a function hash representative of the function 117. The hash may be a one-way hash such as an MD5, SHA512 hash or the like. In alternative embodiments, client terminal 101 securely transfers the function data 114 to the server 102 wherein the server 102 creates the function hash representative of the function 117.

A function hash may hash an asset ID of the asset 117, a function ID of the function 117 and/or associated function data 114. In this case, the associated function data 114 may comprise at least one digital image of the vehicular asset 117 and GPS location coordinates.

For example, the following function data 114 structured meta data may be hashed:

{
“AssetID”: 1835
“Function ID”: 0012
“Function data”:

{

“Coords”:
{

“Lat”: 49.227239
“Long”: 17.564932

}
“Base64Img”: c2Fsa2Rjbjthc2tsY25ham...

}

}

To produce the following function hash:
74c3da400be6de801838d00a7f48948736111667ba4464402c8c86509f7f02a9f797384641ce4525c29fbdd7d647d8ebd6df669a06bfd519f8826832c0bccba3

The client terminal 101 may upload the function data 114 to the database 113.

At step 135, the function hash may be signed with the private key 109 associated with the user 131. In embodiments, the asset ID, function ID and function data 114 is hashed to a first hash which is then cryptographically signed using the private key 109 and the cryptographic encoding is further hashed again to generate a resultant function hash.

Typically, the function hash is shortened, such as 250 characters or less so as to be suitable for typically data limited data fields of block chain transactions. In embodiments, the hash may be stored in the OP_RETURN field of a block chain transaction.

At step 136, the function block chain transaction is broadcast to the network which is picked up by the block chain transaction controllers 175 along with other transactions and eventually added to the block chain ledger 118 as a block, thereby being an immutable record of the application verification function 117 in respect of the vehicular asset 116.

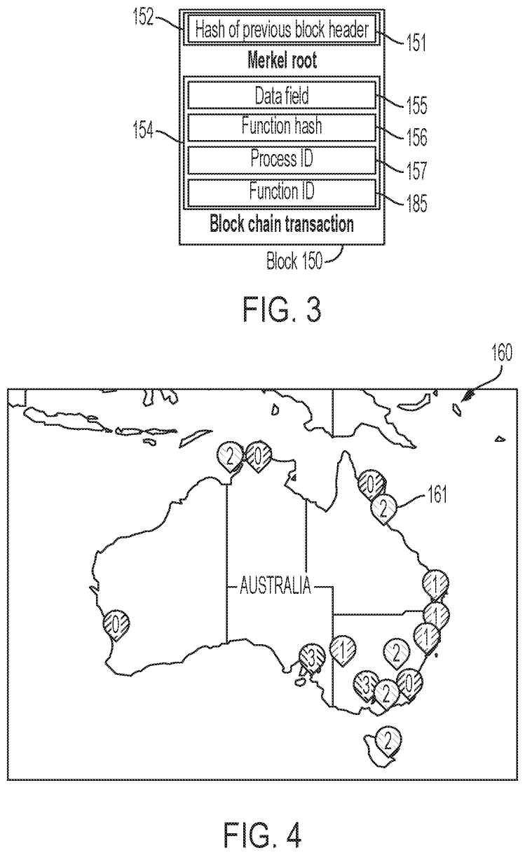

FIG. 3 illustrates a block 150 of the block chain ledger 118. The block 150 may comprise a hash of the previous block header 151 and a Merkel root 152. The Merkel root 152 may comprise a plurality of function block chain transactions 154.

The block chain transactions 154 may comprise a data field 155. As alluded to above, for public block chains, such as the Bitcoin™ block chain, the data field 150 may be the OP_RETURN field. For private block chains, a custom data field may be utilised.

The data field 155 may comprise the function hash 156.

In embodiments, the data field 155 further comprises a process ID 157. For example, the audit process may be assigned a unique process ID 157. As such, when subsequently inspecting the block chain ledger 118 for functions transactions 154 relating to a particular process, the process ID is 157 of the data fields 155 may be inspected to quickly pull the relevant transactions from the block chain ledger 118.

In embodiments, an index, such as a binary tree search index of the process IDs 157 is stored separately to allow for the rapid searching of the block chain ledger 118.

In embodiments, the process ID 157 may be stored in a separate data field as that of the function hash 156. In alternative embodiments, the process ID 157 may be a prefix offset character length and the function hash 156 be a suffix, preferably also of a set character length. As such, the combined process ID 157 prefix and function hash 156 suffix may be included within the index to allow for the rapid searching thereof by the leading characters to obtain the prefix function hash.

In embodiments, a function ID 185 may also be stored in the data field 155 or separate data field associated with the function block chain transaction 154. In this way, for each function block chain transaction 154, the process ID 157 may be used to identify a process, the function ID 185 may be used to identify a function 117 within the process and the function hash 156 used to verify the function 117.

In alternative embodiments, as opposed to the block chain transaction 154 comprising information stored within a data field 155 thereof, a separate index may be employed having the block chain hash as an index for the reverse look up of relevant information, such as process ID, transaction ID, asset ID, user ID and the like, thereby avoiding storage of such within the block chain ledger 118.

In preferred embodiments, the present system 100 comprises automated function verification performed by the function verification controller 176.

Specifically, at stage II 179, the function verification controller 176 may detect the addition of a new block to the block chain ledger 118 and obtain the function block chain transactions 137 therefrom.

The function verification controller 176 may identify a process using the process ID 157 and a function 117 using the function ID 185 either from the data field 155 or a separate index.

The function verification controller 176 may be configured for verifying the function 117.

For example, the function verification controller 176 may inspect the database 113 to obtain the function data 114 therefrom. As alluded to above, for the present audit process, the function data 114 may comprise GPS location data and image data.

Similarly, the function data 114 within the database 113 may be stored in relation to the process ID 157 and the function ID 185.

As such, using the process ID 157 and the function ID 185 obtained from the block chain transaction 154 or separate index, the function verification controller 176 is able to retrieve the GPS location data and image data from the function data 114 of the database 113.

The function verification controller 176 may then perform hashing thereon along with the process ID 157 and the function ID 185 to generate a check hash. The function verification controller 176 may check that the check hash matches the function hash 156 so as to be able to verify the authenticity of the function data 114 stored within the database 113.

The function verification controller 176 may reference the plurality of transaction contracts 124 within the database 115.

For example, a transaction contract 124 may be specified within the database 115 with a trigger 125 matching a particular process ID 157 and a particular function ID 185. For the present example, the transaction contract 124 may comprise a trigger 125 which is executed when a function block chain transaction is added to a block of the block chain ledger 118 specifying the verification of the location of an asset in an audit process.

Once the trigger 125 is matched, the function verification controller 176 may apply the rules 126 thereon to verify the transaction.

For example, operational requirements may require that at least two images of the vehicular asset be recorded within the database 113. As such, the rules 126 may instantiate the automation processor 117 to inspect the function data 114 within the data base 113 to verify that there are indeed at least two images of the vehicular asset.

In embodiments, the transaction contract 124 may utilise inputs 127. For example, the function data 114 within the database 113 may represent a serial number stored in relation to an “apply serial number” function 117. As such, the rules 126 may verify that the applied serial number matches a particular format.

In embodiments, the function verification controller 176 utilise the supervised machine learning module 129 to verify transactions.

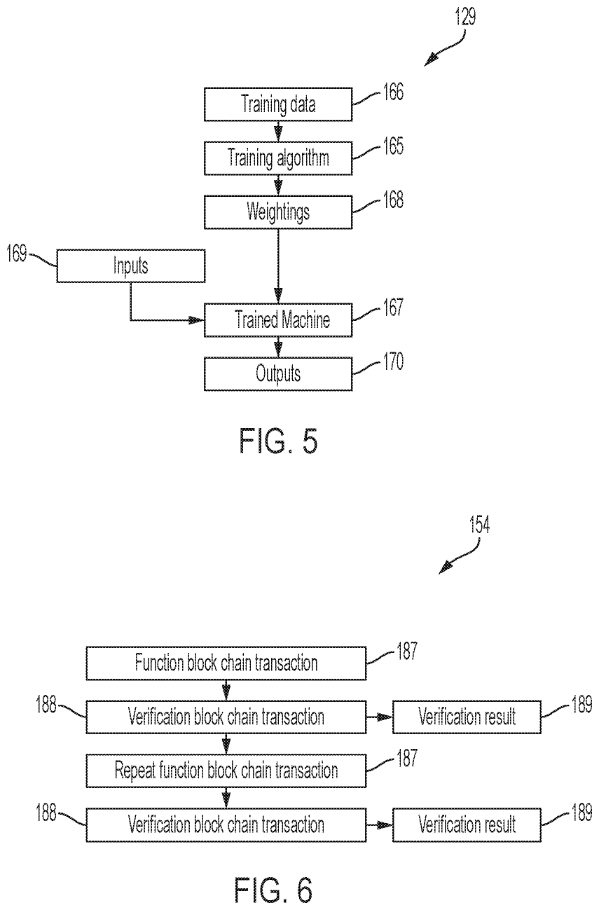

Specifically, FIG. 5 illustrates supervised machine learning module 129 of the system 100.

The module 129 comprises a training algorithm 165 which optimises a trained machine 167. In embodiments, the trained machine 167 comprises a neural network such that the training algorithm 165 optimises weightings 168 of nodes thereof.

The training algorithm 165 has as input training data 166 which adjust the weightings 168 of the trained machine 167 to optimise the output 170 thereof. As such, in use, the trained machine 167 may comprise one or more inputs 169 to generate one or outputs 170 allowing for the self-learning/artificial intelligence of the system 100.

For example, in embodiments, a “purchase asset” function 117 may require the uploading of an invoice. Using the image capture device 183 of the client terminal 101, a user may capture an image of a paper-based invoice. The transformation and encoding controller 171 may convert the image to text.

The trained machine 166 may be trained to verify whether the provided information “looks like” and invoice and/or comprises typical invoice data.

For example, the training data 166 may comprise images from an image data set of a plurality of images such that the optimised trained machine 167 is able to output an output 170 of the likelihood of input image data 169 “looking like” and invoice.

The output 128 of the function verification controller 176 may be a verification block chain transaction which is added to the block chain ledger 118. Alternatively, the output 128 of the function verification controller 176 may be used by the automation processor 117 to, for example, send a notification to a client terminal 101. For example, such a notification may include a notification that an image was uploaded that does not look like on invoice, a vehicle asset location verification function was performed without uploading the requisite number of images or that a particular function has been completed.

In embodiments, the output 128 generated at step 140 may indicate that a task has been incorrectly performed and that it should be repeated to be corrected.

For example, for the aforedescribed example of the user 131 not uploading the requisite number of images for the vehicular asset location verification function 117, a verification block chain transaction may be added to the block chain ledger 118 indicative that the previous block chain transaction, or a block chain transaction identified by a transaction ID is invalid.

The verification block chain transaction may comprise a result stored within the data field 155. For successfully completed transactions, the result may be 1 to represent that the reference transaction was successfully completed or be 0 to represent that the reference transaction was in successfully completed.

As such, the process may be repeated such that a further corrected block chain transaction is added to the block chain 118.

For example, with reference to FIG. 6, there is shown a plurality of block chain transactions 154 which may comprise first and second function block chain transactions 187. The function verification controller 176 may have been configured to verify the second function block chain transaction 187 (such as by with reference to process or function ID) and output a verification block chain transaction 188 to the block chain ledger 118. The verification block chain transaction 188 comprises a verification result indicative of the successful completion or not of the previous or referenced function block chain transaction 187.

As such, the function block chain transaction 187 may be repeated such that a further function block chain transaction 187 is added to the block chain ledger 118. The further function block chain transaction 187 may be a repeat function block chain transaction 187.

The term “repeat function block chain transaction” as used herein should be construed as a block chain transaction which is used by the system 100 to verify that a function block chain transaction has been repeated. As such, the repeat function block chain transaction 187 may reference the verification block chain transaction 188. For example, the repeat function block chain transaction 187 may comprise a data field comprising a transaction ID of the verification block chain transaction 188. Alternatively, the relationship may be stored within a separate index using the respective transaction IDs for reference.

The server 100 to may further comprise a process verification controller 187 which may be used to subsequently verify a process. For example, for a provided process ID, the process verification controller 187 may pull all function, verification and repeat function block chain transactions from the block chain ledger 118 for inspection.

For each verification block chain transaction 188 having a verification result indicative of an unsuccessful completion of a function block chain transaction 187, the process verification controller 187 may be configured for verifying that the block chain ledger 118 comprises a subsequent or associated repeat function block chain transaction 187 and that a verification block chain transaction 188 associated with the repeat function block chain transaction 187 has a positive verification result 189.

In embodiments, the function verification controller 176 may use an enterprise database API 182 to retrieve data from at least one enterprise database for verification. For example, for function data 114 representative of a registration number of a vehicular asset 116, the function verification controller 176 may retrieve a registration number from an enterprise database for confirmation.

As such, step 140 of the processing 130 may comprise the function verification controller 176 generating an output of the stage II 179 at step 140.

Exemplary stage III 180 may involve two users, comprising an operational user 141 and a manager user 142. The hierarchical relationship between the operational user 141 and the manager user 142 may be represented by the hierarchical relations 122 stored within the database 115.

In this example, the operational user 141 may receive an alert generated by the automation processor 177 via a client terminal 101 of the successful completion of stage I 178 by user 131. As such, the operational user 141 may be required to check the audit performed by user one 131 such as by, for example, counting the number of vehicles at the particular location to ensure that the number counted matches the total number of location verification functions 117 recorded.

In a similar manner, the operational user 141 may select an audit verification function 143. However, the operational user 141 may be required to report to the manager user 142 for sign off.

As such, at step 144, the audit verification function ID and associated function data 114 (which, for example, may comprise an electronic signature, or scanned copy of a signed document) may be hashed at step 144.

However, the function ID and the function data may be signed with the private key 109 of the operational user 141 at step 145 and signed again with the private key 109 of the manager user 142 at step 146, thereby indelibly recording that both the operational user 141 and the manager user 142 have signed the transaction which is then broadcast and added to the block chain at step 147.

FIG. 4 shows an exemplary map representation 160 comprising a plurality of icons 161 indicative of various operational processes. For example, using the aforedescribed example, each icon 161 may represent an asset audit process. Utilising the GPS location data recorded within the database 113, each icon 161 may be respectively placed on the map representation 160 according to particular locations.

Each icon 161 may be colour-coded to represent the status of the process is determined by the process verification controller 187. For example, the colour green may indicate that a process has been completed successfully and has been verified, the colour orange may indicate that a process is been completed and the colour red represent that a process is either complete or incomplete but has failed a verification test.

In embodiments, the process verification controller 187 may invoke the function verification controller 176 in real-time to verify transactions so as to be able to further verify transactions without necessarily reference to verification block chain transactions within the block chain ledger 118.

The foregoing description, for purposes of explanation, used specific nomenclature to provide a thorough understanding of the invention. However, it will be apparent to one skilled in the art that specific details are not required in order to practise the invention. Thus, the foregoing descriptions of specific embodiments of the invention are presented for purposes of illustration and description. They are not intended to be exhaustive or to limit the invention to the precise forms disclosed as obviously many modifications and variations are possible in view of the above teachings. The embodiments were chosen and described in order to best explain the principles of the invention and its practical applications, thereby enabling others skilled in the art to best utilize the invention and various embodiments with various modifications as are suited to the particular use contemplated. It is intended that the following claims and their equivalents define the scope of the invention.

The term “approximately” or similar as used herein should be construed as being within 10% of the value stated unless otherwise indicated.

1. A system comprising
a server comprising a database, the database comprising user data, the server further comprising a process verification controller;
a block chain ledger;
a plurality of client terminals in operable communication with the server across a wide area network, each client terminal comprising a memory device; a digital display device comprising a user interface wherein, in use, the system is configured for:
for each stage of a multistage process involving a plurality of users:
receiving a function ID selected from a set of available functions via user interfaces of respective client terminals and generating a function hash comprising the function ID and associated function data;
creating a function block chain transaction comprising the function hash; and
adding the function block chain transaction to the block chain ledger; and
using the process verification controller to inspect the function block chain transactions to verify the multistage process, wherein:
the process has a process ID and wherein function block chain transactions comprise a data field comprising the process ID and wherein the process verification controller is configured for identifying function block chain transactions relating to the process by identifying the process ID of data fields thereof; and
the system comprises a function verification controller configured to inspect the function block chain transactions and to add verification block chain transactions to the block chain ledger and wherein the process verification controller is configured for verifying the process further with reference to the verification block chain transactions and wherein, for a verification block chain transaction comprising a verification result indicative of unsuccessful completion of a function, the process verification controller is configured for inspecting the block chain ledger for a repeat function block chain transaction associated with a function block chain transaction associated with the verification block chain transaction

2. A system as claimed in claim 1, wherein the function hash is a one-way function hash.

3. A system as claimed in claim 1, wherein the database comprises asset data and wherein the system is further configured for receiving an asset ID in relation to the function ID and hashing the asset ID with the function ID and the function data to generate the function hash.

4. A system as claimed in claim 3, wherein the available functions are filtered according to asset ID.

5. A system as claimed in claim 1, wherein the server is configured for building a process ID index which is searched by the process verification controller.

6. A system as claimed in claim 1, wherein each verification block chain transaction comprises a verification result and wherein the process verification controller is configured for verifying the process according to verification results of the verification block chain transactions.

7. A system as claimed in claim 1, wherein each verification block chain transaction comprises a transaction ID of a function block chain transaction.

8. A system as claimed in claim 7, wherein each repeat function block chain transaction comprises a transaction ID of a verification block chain transaction.

9. A system as claimed in claim 1, wherein the system further comprises a function verification controller configured to verify function block chain transactions added to the block chain ledger.

10. A system as claimed in claim 9, wherein the database comprises at least one transaction contract and wherein the function verification controller is configured for verifying function block chain transactions using the at least one transaction contract.

11. A system as claimed in claim 10, wherein the function block chain transaction comprises a data field comprising a transaction ID and wherein the function verification controller is configured for selecting a transaction contract from the at least one transaction contract according to the transaction ID.

12. A system as claimed in claim 10, wherein the function contract specifies at least one rule and an output.

13. A system as claimed in claim 12, wherein the function verification controller is configured for creating a verification block chain transaction in accordance with the output and adding the verification block chain transaction to the block chain.

14. A system as claimed in claim 13, wherein the verification block chain transaction comprises a data field comprising the output.

15. A system as claimed in claim 9, wherein the system further comprises a supervised machine learning module and wherein the function verification controller is configured for verifying a function block chain transaction in accordance with an output of the supervised machine learning module.

16. A system as claimed in claim 13, wherein the system is configured for storing the function data within a function data database separate from the block chain ledger and wherein the function verification controller is configured for identifying the function data within the function data database using a function block chain transaction and hashing the function data to form a check hash and comparing the check hash against the function hash of the function block chain transaction verify the function block chain transaction.

17. A system as claimed in claim 1, wherein the server comprises an automation processor configured to monitor the block chain ledger and automate a process when a function block chain transaction is added to the block chain.

18. A system as claimed in claim 17, wherein the function block chain transaction comprises a data field comprising a function ID and wherein the automation processor is configured to automate the process when the function ID matches an automation process ID.

19. A system as claimed in claim 18, wherein the process is the sending of an alert to a client terminal.

20. A system as claimed in claim 9, wherein the function hash is cryptographically signed with a private key associated with a respective user and wherein the function verification controller is configured for verifying the function hash using a corresponding public key of a cryptographic key pair.

21. A system as claimed in claim 20, wherein the database further comprises user hierarchy data and wherein the function hash is cryptographically signed with private keys of at least two users related by the hierarchy data.
